(19) United States
(12) Patent Application Publication
(10) Pub. No.: US 2011/0123428 A1
(43) Pub. Date: May 26, 2011

(54) METHOD AND SYSTEM FOR PRODUCING CALCIUM CARBIDE

(76) Inventors: Zhenyu Liu, Beijing (CN); Qingya Liu, Beijing (CN); Guodong Li, Beijing (CN)

(21) Appl. No.: 13/017,207

(22) Filed: Jan. 31, 2011

Related U.S. Application Data
(63) Continuation of application No. PCT/CN2009/072770, filed on Jul. 15, 2009.

(30) Foreign Application Priority Data
Aug. 1, 2008 (CN) CN 200810117540.2
Dec. 12, 2008 (CN) CN 200810239805.6

(51) Int. Cl. C01B 31/32; B01J 8/02; B01J 8/00; B01J 8/18

(52) U.S. Cl. 423/442; 423/441; 422/198; 422/146; 422/187

(57) ABSTRACT

A method and a system for producing calcium carbide, the method including mixing powdery carbon-containing raw material with powdery calcium-containing raw material, and directly heating the mixture by combusting a part of carbon-containing raw material in an oxygen-containing atmosphere to produce calcium carbide. The carbon-containing raw material can be coal, semi-coke or coke, the calcium-containing raw material can be calcium carbonate, calcium oxide, calcium hydroxide or carbide slag. The system includes a raw material preheating unit, such as a fluidized bed or an entrained flow bed, and a reaction unit such as an entrained flow bed. By combustion of the by-product CO produced during the production of calcium carbide or auxiliary fuel in the air to preheat the raw materials to 500-1500° C., the carbon consumption and the oxygen consumption for the calcium carbide production can be reduced, and thus process energy consumption is further reduced.

### CROSS-REFERENCE TO RELATED APPLICATIONS

This application is a continuation application of pending PCT Application No. PCT/CN2009/072770, filed Jul. 15, 2009, the disclosure of which is incorporated by reference in its entirety, which claims the priority of Chinese Invention Patent Application No. 200810117540.2 filed on Aug. 01, 2008, and Chinese Invention Patent Application No. 200810239805.6 filed on Dec. 12, 2008, which are incorporated herein by reference in their entirety.

### TECHNICAL FIELD

The present invention relates to a method and a system for producing acetylene stones (i.e., calcium carbide (CaC₂)), and more specially, to a method and a system for producing calcium carbide by providing heat directly through partial combustion of a powdery carbon-containing raw material and a powdery calcium-containing raw material in an oxygen-containing atmosphere.

### BACKGROUND ART

Acetylene stone, i.e. calcium carbide, is one of the basic materials in the organic synthetic chemistry industry. A series of organic compounds can be synthesized by using the calcium carbide as raw material, to provide source materials for fields such as industry, agriculture, and medicine, and calcium carbide is honored as the mother of organic synthesis before the middle of last century. Hydrolysis of calcium carbide results in acetylene and calcium hydroxide and reaction of calcium carbide with nitrogen produces calcium cyanamide. At present, acetylene is mainly used for producing vinyl chloride based, vinyl acetate based and acrylic acid based products and the like. For example about 70% of PVC (polyvinyl chloride) production in China is originated from carbide acetylene. In recent years, rising oil price promoted industrial development of calcium carbide, and calcium carbide production in China increased from 4.25 million tons in 2002 to 11.77 million tons in 2006.

Typically, the calcium carbide production is based on the following reaction formula, i.e. CaO+3C→CaC₂+CO, which is an endothermic reaction.

The existing production methods for acetylene stone is the fixed bed-electric arc approach, which uses electric arc to heat large particles of calcium oxide and large particles of coke in a fixed bed (also known as moving bed, or electric arc furnace) to temperatures higher than 2000° C. for a certain period of time to produce molten acetylene stone. In the production process, a mixture of calcium oxide and coke is added through the top of the electric furnace. The CO produced by the reaction between the calcium oxide and the coke passes through the gap between block materials and is vented through the top of the furnace. The molten acetylene stone produced is discharged from the bottom of the furnace and then cooled and broken for final product.

The biggest shortcoming of the fixed bed-electric arc approach is heavy power consumption. It was reported that production of 1 ton acetylene stone with a purity of 85% consumes 3250 kW·h of electricity in average in China. In addition, the electric arc furnace is complex in structure, small in furnace volume, large in electrode consumption and high in equipment and operation costs.

It was reported that, acetylene stone can also be produced by fixed bed-oxygen heating process. A Japan patent (SHO 61-178412) disclosed an oxygen heating process with a tower furnace and coke as the fuel. CN 1843907A disclosed a method and an equipment for calcium carbide production with oxygen or oxygen-rich gas jetting technology in a tower furnace, where coal, natural gas, heavy oil and other relatively inexpensive fuels are used as the fuel, and the gaseous by-product CO is used for producing coal gas. However, the said oxygen heating processes still require large particle feed and batch operation mode, which lead to long reaction time, several times more coke consumption and low throughput and thus result in production costs of higher than the electric arc process. For these reasons these processes are not competitive with the electric arc process.

In short, both of the above-mentioned approaches adopt fixed bed reactor and large particle raw materials (3-40 mm), and batch operation mode, so that the reaction rate is low, the residence time of material in the furnace is long, production capacity is small, and energy consumption per unit product is very high. In addition, the mass loss in preparation of large particle raw material is very large, 20% or more in general being too fine to be used.

CN85107784A and CN88103824.5 disclosed a method for producing calcium carbide with powdery raw materials in a reactor containing a certain amount of molten calcium carbide, which operates intermittently and has a small production capability. A US patent (U.S. Pat. No. 3,044,858A) disclosed a method for producing calcium carbide with powdery raw materials in an entrained flow bed. In this method, the raw materials are injected from the bottom of a reactor, and the gaseous and the solid products are discharged from the top of the reactor, which results in poor contact of raw materials, short reaction time and low conversion. Also, calcium carbide and calcium oxide form eutectic at temperatures higher than 1660° C., which coheres with the raw materials to form blocks, tending to cause accident in operation; and the adopted moving bed preheating approach is extremely prone to cause jam, resulting in poor operability.

The primary causes of the disadvantages such as “high investment, high energy consumption, and heavy pollution” presented in these processes are the adoption of large particle raw material and intermittent operation mode, which leads to small scale operation and difficulties in gaseous by-product CO utilization.

### SUMMARY OF THE INVENTION

The present invention aims to overcome the disadvantages such as “high investment, high energy consumption, and heavy pollution” presented in conventional acetylene stone production processes, and to provide an acetylene stone production method and system with simple process, low energy consumption, wide sources of raw materials, continuous production, large production capacity and low cost.

According to one aspect of the present invention, a method for producing acetylene stone based on oxygen heating process is provided, which includes the following steps: (1) preparing a powdery carbon-containing raw material with a particle size of smaller than 1 mm and a powdery calcium-containing raw material with a particle size of smaller than 1 mm; (2) mixing said powdery carbon-containing raw material and said powdery calcium-containing raw material at weight ratios of 0.5-3:1; (3) heating said mixture directly through partial combustion of said carbon-containing raw material in oxygen-containing atmospheres, wherein the mol ratio of O₂ in the oxygen-containing atmosphere to the C in the carbon-containing raw material is 0.1-0.6, leading to reaction temperatures of said mixture to 1700-1950° C.

Preferably, the weight ratios of the carbon-containing raw material to the calcium-containing raw material are 0.7-2:1.

Preferably, the particle sizes of the powdery carbon-containing raw material and the calcium-containing raw material are both smaller than 0.3 mm.

The carbon-containing raw material can be coal, semi-coke, coke, or their mixture. The calcium-containing raw material can be calcium carbonate, calcium oxide, calcium hydroxide, carbide slag, or their mixture.

It is also possible to add a preheating step after Step (2) to preheat the mixture of the powdery carbon-containing raw material and the powdery calcium-containing raw material to temperatures between 500-1500° C. The fuel used in the preheating step can be the powdery carbon-containing raw material, the gaseous product CO obtained in the production process of the acetylene stone, or an auxiliary fuel. The auxiliary fuel includes a gaseous fuel or a liquid fuel. The oxygen-containing gas used in the preheating process can be oxygen, oxygen-enriched air, or air, preferably air. If the preheating fuel is the gaseous product CO obtained in the acetylene stone production process, the preferred ratio of CO to air is 1:2.5-4 in volume.

The addition of the preheating step can not only decrease consumption of the carbon-containing raw material in following process to get higher purity of acetylene stone, but also reduce oxygen consumption in the reaction of calcium carbide production. If the by-product CO produced in the acetylene stone production process is discharged to the atmosphere, it will surely lead to air pollution. The use of by-product CO as the preheating fuel in the present invention not only prevents air pollution but also increases energy efficiency.

According to another aspect of the present invention, a system to achieve said method is provided, which includes a raw material preheating unit, and a reaction unit. The raw material preheating unit includes a raw material mixing and feeding device, a preheating device, a gas compression device, and a first heat exchanger. The raw material mixing and feeding device includes a solid raw material mixer and a feeder, and the outlet of the solid raw material mixer is connected with the inlet of the feeder. The preheating device is provided with a raw material entrance, a gas inlet, a first gas outlet, and a first solid material outlet. The outlet of the raw material mixing and feeding device is connected with the raw material entrance of the preheating device, and the preheating device is connected with the gas compression device through a gas inlet. The preheating device is connected with the first heat exchanger through the first gas outlet. The reaction unit includes a feeding device, a reactor, and a second heat exchanger. The reactor is provided with a raw material injection port, a second gas outlet, and a product discharge port. On the raw material injection port is an oxygen-containing gas entrance. The solid material entrance of the feeding device is connected with the first solid material outlet of the preheating device. The solid material outlet of the feeding device is connected with the raw material injection port of the reactor. The second gas outlet of the reactor is connected with the gas entrance of the second heat exchanger. The product, calcium carbide, is discharged through the product discharge port at the bottom of the reactor and the gaseous by-product is discharged through the second gas outlet on an upper portion of the reactor to the second heat exchanger. After heat exchange, a part of the gaseous by-product enters the gas compression device of the preheating unit, and a part of the gaseous by-product enters other units.

Preferably, the feeder is provided with a gas purging port to prevent the feeder from being blocked by solid raw materials.

Preferably, the preheating device includes a preheater. The preheater can be a fluidized bed or an entrained flow bed. If the preheater is an entrained flow bed, the preheating device further includes a gas-solid separator on which the first gas outlet and the solid material outlet of the preheating device are provided. The gas flowed out of the first gas outlet is discharged through the first heat exchanger.

The gas-solid separator is preferably a cyclone separator.

In addition, a gas purging port can be further provided on the feeding device of the reaction unit to prevent the feeding device from being blocked by materials.

The feeder and the feeding device can be selected according to material temperature, and can be a screw feeder or U-type pneumatic valve feeder. Taking into account that the material temperature of the feeder is low, the feeder is preferably a screw feeder. Taking into account that the material temperature of the feeding device is high, the feeding device is preferably a U-type pneumatic valve feeder.

The raw material injection port of the reactor can be a single injection port, doublet injection ports, or multiple injection ports.

It is also possible to consider providing an auxiliary fuel entrance on the connection pipeline of the second heat exchanger and the gas compression device.

It is also possible to provide a storage device between the preheating device and the feeding device of the reaction unit.

As compared with current methods for producing acetylene stone, the present invention adopts powdery raw materials, which takes the advantages of abundant sources, high utilization rate, high reaction rate, low reaction temperature and large production capacity. The adopted direct heating by partial combustion of the carbon-containing raw material to replace electric arc heating leads to simplified reactor, low cost and low energy consumption.

By preheating the raw material with the gaseous by-product CO, coke making, lime calcining and raw material preheating are done in one unit, and thus the whole system is effective in energy saving.

### BRIEF DESCRIPTION OF THE DRAWINGS

FIG. 1 is a block diagram showing steps of a method according to the present invention without a preheating step;

FIG. 2 is a block diagram showing steps of a method according to the present invention with a preheating step;

FIG. 3 is a schematic diagram of a system according to the present invention, in which the preheating device shown is a fluidized bed;

FIG. 4 is a schematic diagram of a system according to the present invention, in which the preheating device shown is an entrained flow bed.

The accompanied drawings described herein are just for the purpose of illustration and not intended to limit the scope of the present invention in any way.

### PREFERRED MODE FOR CARRYING OUT THE INVENTION

Next, the present invention will be described in detail with reference to the accompanied drawings, wherein the same reference numerals denote the same or similar components.

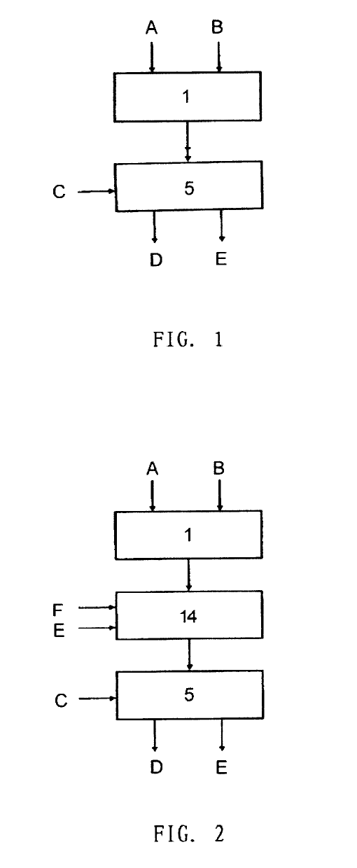

FIGS. 1 and 2 are block diagrams showing steps of a method according to the present invention. FIG. 1 does not include a preheating step, whereas FIG. 2 includes a preheating step. As shown in FIG. 1, a powdery carbon-containing raw material A and a powdery calcium-containing raw material B, which have appropriate particle sizes and an appropriate weight ratio proportioned by a dosing unit (not shown), are fed into and mixed uniformly by a raw material mixing and feeding device 1. Then, the mixed raw materials and an appropriate amount of oxygen-containing gas C are injected into a reactor 5, where a part of the carbon-containing raw material A is burned with O₂ to directly heat the remaining mixture to a temperature between 1700 -1950° C., and a high temperature reaction occurs to produce acetylene stone D and a gaseous by-product CO E. The acetylene stone D are discharged from the reactor and then cooled to ambient temperature.

As shown in FIG. 2, the mixture of the raw materials can also be preheated to temperatures of 500-1500° C. by combustion of the gaseous by-product CO E produced in acetylene stone production process with an oxygen-containing gas F in a preheater 14. Then, the preheated mixture and an oxygen-containing gas C are injected into the reactor 5, in which a part of the carbon-containing raw material is burned in the oxygen-containing atmosphere to heat the mixed raw materials to temperatures of 1700-1950° C. The acetylene stone D produced is discharged from the reactor and then cooled to ambient temperature.

Table 1 shows different situations of solid products obtained by methods of the present invention at different particle size, different ratio of the raw materials and different amounts of oxygen with or without preheating, where “g” means grams and “l” means liters at standard pressure and temperature.

TABLE 1

| | Examples | | | | | | | | |
|---|---|---|---|---|---|---|---|---|---|
| | 1 | 2 | 3 | 4 | 5 | 6 | 7 | 8 | 9 |
| Calcium-containing | Calcium | Calcium | Calcium | Calcium | Calcium | Calcium | Calcium | Carbide | Calcium |
| raw material | oxide | oxide | oxide | oxide | carbonate | oxide | hydroxide | slag | oxide |
| Weight(g)/particle | 120/0.63 | 120/0.13 | 120/0.13 | 120/0.16 | 215/0.40 | 120/0.13 | 159/0.13 | 188/0.13 | 120/0.63 |
| diameter(mm) | | | | | | | | | |
| Carbon-containing | Coke | Coke | Coke | Coke | Coke | Powdered | Coke | Coke | Coke |
| raw material | 150/0.63 | 120/0.13 | 125/0.13 | 190/0.16 | 150/0.40 | coal | 140/0.13 | 126/0.13 | 150/0.63 |
| Weight(g)/particle | | | | | | 145/0.13 | | | |
| diameter(mm) | | | | | | | | | |
| Oxygen (l) | 66 | 60 | 128 | 114 | 36 | 73 | 116 | 68 | 64 |
| Reaction temperature | 1750 | 1750 | 1950 | 1750 | 1750 | 1800 | 1750 | 1750 | 1700 |
| (° C.) | | | | | | | | | |
| Reaction time (min) | 10 | 5 | 2 | 7 | 10 | 5 | 5 | 5 | 15 |
| Amount of solid | 192 | 149 | 144 | 189 | 193 | 164 | 152 | 174 | 194 |
| product (g) | | | | | | | | | |
| Purity of acetylene | 68 | 78 | 88 | 73 | 66 | 71 | 77 | 68 | 69 |
| stone (%) | | | | | | | | | |
| Yield of acetylene | 237 | 274 | 309 | 254 | 232 | 249 | 272 | 238 | 240 |
| (l/kg) | | | | | | | | | |
| Preheating or not | No | Yes | No | No | Yes | Yes | Yes | Yes | No |
| CO for preheating (l) | | 48 | | | 48 | 48 | | | |
| CH₄ for preheating (l) | | | | | | | 5 | | |
| Diesel oil for | | | | | | | | 8 | |
| preheating (g) | | | | | | | | | |
| Air for preheating (l) | | 120 | | | 120 | 120 | 50 | 140 | |
| Preheating | | 1500 | | | 900 | 1300 | 500 | 900 | |
| temperature (° C.) | | | | | | | | | |

As can be seen from Table 1 that the reaction temperature decreases to 1700° C. by use of the method in the present invention. A smaller particle of the raw material and a higher reaction temperature yield a shorter reaction time, wherein the reaction time is mostly shortened to less than 10 minutes. In addition, the preheating can decrease the amount of coke consumption and the amount of oxygen consumption.

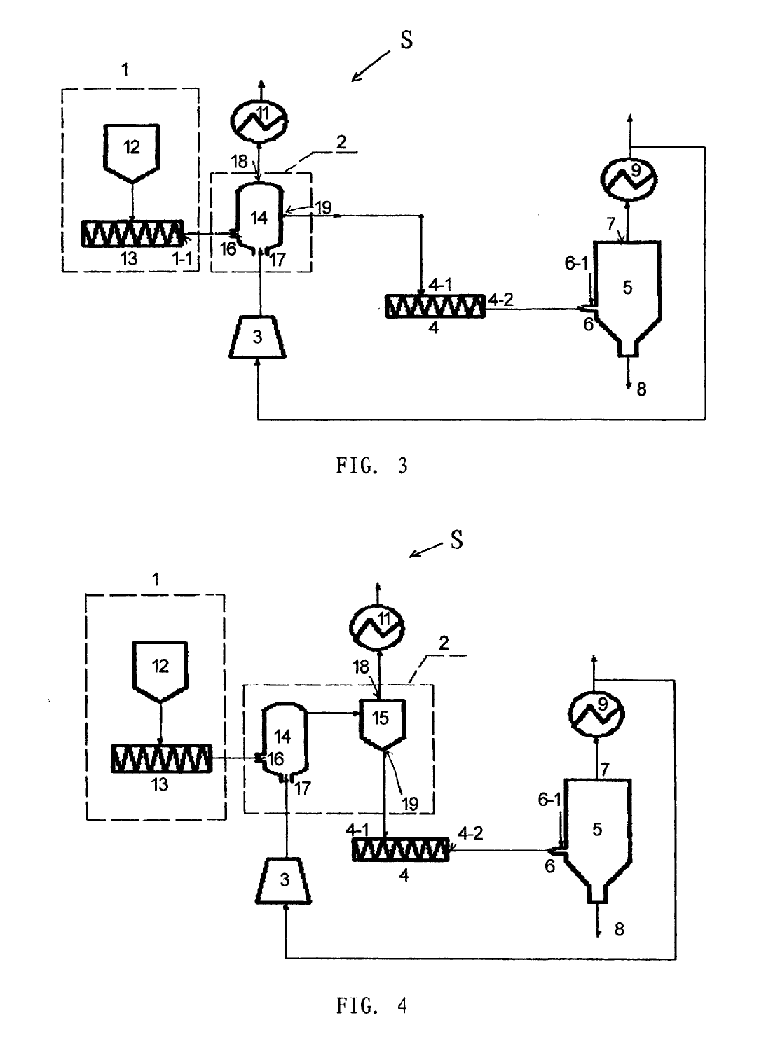

FIGS. 3 and 4 are schematic diagrams of systems in the present invention, in which the preheater shown in FIG. 3 is a fluidized bed, while the preheater shown in FIG. 4 is an entrained flow bed.

Referring to FIG. 3, the system according to the present invention is generally denoted by the reference numeral S, which includes a dosing unit (not shown), a raw material preheating unit, and a reaction unit. The raw material preheating unit includes a raw material mixing and feeding device 1, a preheating device 2, a gas compression device 3, and a first heat exchanger 11. The raw material mixing and feeding device 1 includes a solid raw material mixer 12 and a feeder 13, with an outlet of the solid raw material mixer 12 being connected with an inlet of the feeder 13. The preheating device 2 is provided with a raw material entrance 16, a gas inlet 17, a first gas outlet 18, and a first solid material outlet 19. An outlet 1-1 of the raw material mixing and feeding device 1 is connected with the raw material entrance 16 of the preheating device 2, and the preheating device 2 is connected with the gas compression device 3 through the gas inlet 17. The preheating device 2 is connected with the first heat exchanger 11 through the first gas outlet 18.

The reaction unit includes a feeding device 4, a reactor 5, and a second heat exchanger 9. The reactor 5 is provided with a raw material injection port 6, a second gas outlet 7 and a product discharge port 8. The raw material injection port 6 is provided with an oxygen-containing gas entrance 6-1. A solid material entrance 4-1 of the feeding device 4 is connected with the first solid material outlet 19 of the preheating device 2. A solid material outlet 4-2 of the feeding device 4 is connected with the raw material injection port 6 of the reactor 5. The second gas outlet 7 of the reactor 5 is connected with a gas entrance of the second heat exchanger 9, and after heat exchange, a part of the gas enters the gas compression device 3 of the preheating unit, and a part of the gas enters other units.

Preferably, the feeder 13 is provided with a gas purging port, to prevent the feeder from being blocked by solid materials.

The preheater 14 included in the preheating device 2 is a fluidized bed.

Referring to FIG. 4, the preheater 14 is an entrained flow bed, the preheating device 2 also includes a gas-solid separator 15, which is provided with the first gas outlet 18 and the first solid material outlet 19. The gas flowing out of the first gas outlet 18 is discharged through the first heat exchanger 11.

The gas-solid separator 15 is preferably a cyclone separator.

Preferably, the feeding device 4 of the reaction unit is provided with a gas purging port, to prevent the feeding device from being blocked by materials.

The feeder and the feeding device can be selected according to the material temperature. The feeder 13 and the feeding device 4 can be a screw feeder or a U-type pneumatic valve feeder. Taking into account that the material temperature of the feeder 13 is low, the feeder is preferably a screw feeder. Taking into account that the material temperature of the feeding device 4 is high, the feeding device is preferably a U type pneumatic valve feeder.

Further, the raw material injection port 6 of the reactor 5 can be a single injection port, doublet injection ports, or multiple injection ports.

It is also possible to consider providing an auxiliary fuel entrance on the pipeline connecting the second heat exchanger 9 and the gas compression device 3.

It is also possible to consider providing a storage device between the preheating device 2 and the feeding device 4 of the reaction unit.

Next, a description will be given to the operation status of the system S according to the present invention.

The powdery carbon-containing raw material A and the powdery calcium-containing raw material B are mixed in the raw material mixer 1, and then sent to the preheating device 2 via the feeder 13. The oxygen-containing gas and the gaseous by-product CO subjected to heat exchange are sent to the gas inlet 17 of the preheating device 2 by the gas compression device 3. A part of the carbon-containing raw material and the gaseous by-product CO subjected to heat exchange are burned in the preheating device 2 under the action of the oxygen-containing gas to heat the mixed raw materials to a temperature between 500-1500° C., so that the carbon-containing raw material A is pyrolyzed into coke powder and the calcium-containing raw material B is pyrolyzed into calcium oxide powder. The hot gas produced is discharged after heat exchange through first heat exchanger 11. The formed high temperature solid mixture is sent to the raw material injection port 6 of the reactor 5 through the feeding device 4, and then injected into the reactor 5 through the injection port 6. The oxygen-containing gas C is injected into the reactor 5 from the oxygen-containing gas entrance 6-1 on the injection port 6. A part of the coke powder is burned with the O₂ in the oxygen-containing gas in the reactor 5, to heat the materials to temperatures between 1700-1950° C. to form acetylene stone. The acetylene stone is discharged through the product discharge port 8 on the bottom of the reactor 5. The gaseous by-product CO is discharged through the second gas outlet 7 on the top of the reactor 5 and enters the second heat exchanger 9, and a part of the gas subjected to heat exchange is injected into the preheating device 2 through the gas compression device 3, to serve as the fuel of the preheating device 2.

In a case where the preheating device 2 includes the gas-solid separator 15, the mixture of raw materials are heated to temperatures in a range of 500 to 1500° C. to pyrolyze the carbon-containing raw material into coke powder and the calcium-containing raw material into calcium oxide powder. The formed high temperature products enter the gas-solid separator 15. The separated gaseous products are discharged after being cooled by the first heat exchanger 11. The separated solid products are sent to the raw material injection port 6 of the reactor 5 through the feeding device 4, and injected into the reactor 5 by the injection port 6. The oxygen-containing gas C is injected into the reactor 5 from the oxygen-containing gas entrance 6-1 on the injection port 6. A part of the coke powder is burned with the oxygen-containing gas in the reactor 5 to heat the materials to temperatures between 1700-1950° C. to form the acetylene stone. The acetylene stone is discharged through the product discharge port 8 on the bottom of the reactor 5. The gaseous by-product CO enters the second heat exchanger 9 through the second gas outlet 7 on the top of the reactor 5, and a part of the gas subjected to heat exchange is injected into the preheating device 2 through the gas compression device 3 to serve as the fuel of the preheating device 2.

While the present invention has been described above with reference to the accompanied drawings, the above description is exemplary in nature and the present invention is not limited to the above-described embodiments.

### INDUSTRIAL APPLICABILITY

According to the present invention, the acetylene stone is produced with the powdery carbon-containing raw material being directly combusted to provide heat, wherein the temperature for the production is similar to that of current entrained flow coal gasification. Compared with the acetylene stone production technology with electric arc heating, the adopted direct combustion heating avoids energy loss in the process of coal→heat→electricity→heat, which leads to an energy saving of about 50%. Compared with the current acetylene stone production technology with large particle raw material and electric arc heating, the adoption of powdery raw material can increase production capacity of the reactor, which can lead to a further energy saving.

As compared with the current technology which prepares the raw materials through coke making and lime calcining separately, the present invention combines the preparation processes of the raw materials and the production process of the acetylene stone to fully use the sensible heat of the coke and the calcium oxide, and thus leads to a further energy saving.

What is claimed is:

1. A method for producing calcium carbide, including the steps of:
(1) preparing a powdery carbon-containing raw material with a particle size of smaller than 1 mm and a powdery calcium-containing raw material with a particle size of smaller than 1 mm;
(2) mixing said powdery carbon-containing raw material and said powdery calcium-containing raw material with a weight ratio of 0.5-3:1;
(3) preheating the mixed raw materials to a temperature of 500 to 1500° C.;
(4) directly heating said mixture through partial combustion of said carbon-containing raw material in an oxygen-containing atmosphere within a reactor having a discharge port on the bottom of the reactor and a gas outlet on the top of the reactor, wherein the mol ratio of O₂ in the oxygen-containing atmosphere to the C in the carbon-containing raw material is 0.1-0.6, causing a reaction temperature of said mixture to be 1700 to 1950° C.;
(5) discharging calcium carbide product through the discharge port on the bottom of the reactor, and discharging gaseous by-product through the gas outlet on the top of the reactor.

2. The method for producing calcium carbide according to claim 1, wherein the weight ratio of the carbon-containing raw material to the calcium-containing raw material is 0.7-2:1.

3. The method for producing calcium carbide according to claim 1, wherein the oxygen-containing atmosphere includes pure oxygen and oxygen-enriched air.

4. The method for producing calcium carbide according to claim 1, wherein the particle sizes of the powdery carbon-containing raw material and the powdery calcium-containing raw material are both smaller than 0.3 mm.

5. The method for producing calcium carbide according to claim 1, wherein the carbon-containing raw material is coal, semi-coke, coke, or their mixture, and the calcium-containing raw material is calcium carbonate, calcium oxide, calcium hydroxide, carbide slag, or their mixture.

6. The method for producing calcium carbide according to claim 1, wherein the fuel used in the preheating step is selected from the group consisting of the powdery carbon-containing raw material, the gaseous by-product CO obtained in the production process, or an auxiliary fuel, and the oxygen-containing gas used in preheating is oxygen, oxygen-enriched air, or air.

7. The method for producing calcium carbide according to claim 6, wherein when the fuel used in preheating is the gaseous by-product CO obtained in the production process of calcium carbide, a volume ratio of CO to air is 1:2.5-4.

8. A system for producing calcium carbide, including a raw material preheating unit, and a reaction unit, wherein the raw material preheating unit includes a raw material mixing and feeding device, a preheating device, a gas compression device, and a first heat exchanger; the raw material mixing and feeding device includes a solid raw material mixer and a feeder, an outlet of the solid raw material mixer is connected with an inlet of the feeder; the preheating device is provided with a raw material entrance, a gas inlet, a first gas outlet, and a first solid material outlet; an outlet of the raw material mixing and feeding device is connected with the raw material entrance of the preheating device, the preheating device is connected with the gas compression device via the gas inlet; and the preheating device is connected with the first heat exchanger via the first gas outlet;
the reaction unit includes a feeding device, a reactor, and a second heat exchanger; the reactor is provided with a raw material injection port, a second gas outlet, and a product discharge port; the raw material injection port is provided with an oxygen-containing gas entrance; a solid material entrance of the feeding device is connected with the first solid material outlet of the preheating device; a solid material outlet of the feeding device is connected with the raw material injection port of the reactor; the second gas outlet of the reactor is connected with the gas entrance of the second heat exchanger, and the gas outlet of the second heat exchanger is connected with the gas compression device of the preheating unit; after heat exchange, a part of gas enters the gas compression device of the preheating unit, and a part of the gas enters other units,
wherein the gaseous reaction product is discharged through the second gas outlet on the top of the reactor, and calcium carbide product is discharged through the product discharge port on a bottom of the reactor.

9. The system for producing calcium carbide according to claim 8, characterized in that the feeder and/or the feeding device of the reaction unit are/is provided with a gas purging port.

10. The system for producing calcium carbide according to claim 8, characterized in that the preheating device includes a preheater which is a fluidized bed or an entrained flow bed; and
if the preheater is an entrained flow bed, the preheating device further includes a gas-solid separator on which the first solid material outlet and the first gas outlet of the preheating device are provided.

11. The system for producing calcium carbide according to claim 10, characterized in that the gas-solid separator is a cyclone separator.

12. The system for producing calcium carbide according to claim 8, characterized in that the feeder and the feeding device are a screw feeder or a U-type pneumatic valve feeder.

13. The system for producing calcium carbide according to claim 8, characterized in that the second heat exchanger and the first heat exchanger each is selected from the group consisting of a tube heat exchanger, a plate type heat exchanger, and a waste heat boiler.

14. The system for producing calcium carbide according to claim 8, characterized in that the raw material injection port of the reactor is selected from the group consisting of a single injection port, doublet injection ports, and multiple injection ports.

15. The system for producing calcium carbide according to claim 8, characterized in that the pipeline connecting the second heat exchanger and the gas compression device is provided with an auxiliary fuel entrance.

16. The system for producing calcium carbide according to claim 8, characterized in that a storage device is provided between the preheating device and the feeding device of the reaction unit.
